(19) United States
(12) Patent Application Publication
(10) Pub. No.: US 2014/0363993 A1
(43) Pub. Date: Dec. 11, 2014

(54) CONNECTION STRUCTURE OF ELECTRONIC COMPONENTS

(71) Applicant: Yazaki Corporation, Tokyo (JP)

(72) Inventor: Shinji MOCHIZUKI, Makinohara-shi (JP)

(73) Assignee: YAZAKI CORPORATION, Tokyo (JP)

(21) Appl. No.: 14/467,463

(22) Filed: Aug. 25, 2014

Related U.S. Application Data
(63) Continuation of application No. PCT/JP2013/056214, filed on Feb. 28, 2013.

(30) Foreign Application Priority Data
Mar. 5, 2012 (JP) 2012-048336

(51) Int. Cl. H01R 25/14

(52) U.S. Cl. CPC H01R 25/145
USPC 439/116

(57) ABSTRACT

Bus bars each having a terminal portion formed on one end thereof is spaced from each other and arranged in parallel within a housing. Each terminal portion is formed with a pair of first right and left contact spring pieces each having a bulge protruded horizontally outward at a side of leading portions abutted against each other. The bulges of the two adjacent inside pieces among the first right and left contact spring pieces elastically contact with a pair of light emitting element contact portions disposed on both lateral surfaces of a semiconductor light emitting element arranged between the pair of bus bars and the respective bulges of the two outside pieces among the first right and left contact spring pieces elastically contact with inner walls of the housing.

### CROSS REFERENCE TO RELATED APPLICATIONS

This application is a continuation of PCT application No. PCT/JP2013/056214, which was filed on Feb. 28, 2013 based on Japanese Patent Application (No. 2012-048336) filed on Mar. 5, 2012, the contents of which are incorporated herein by reference.

### BACKGROUND OF THE INVENTION

1. Field of the Invention

The present invention relates to a connection structure of electronic components capable of establishing electrical connection of the electronic components having different pitches between contacts.

2. Description of the Related Art

A connection structure of electronic components which obtains high reliability, by reliably establishing electrical connection of the electronic components is disclosed in JP-A-2007-149762. As shown in FIG. 14, in this connection structure of the electronic components, a pair of bus bars 501, 503 are assembled to a housing, and a semiconductor light emitting element (LED) 505, which is a light source, is also assembled to the housing. The bus bars 501, 503 in a shape of a bifurcated flat plate have a wire connecting part 507, a Zener diode connecting part 509, a resistor connecting part 511, and an LED connecting part 513. In the resistor connecting part 511, pressure-contacting blades 515, 515 are respectively provided on the bus bars 501, 503 which are bifurcated. In the Zener diode connecting part 509, a single pressure-contacting blade 517 is provided on one of the bus bars 501, and a single pressure-contacting blade 519 is provided on the other bus bar 503.

A Zener diode 521 is connected to a pair of the bus bars 501, 503 in parallel therewith, at a downstream side of a resistor 527, in such a manner that one of lead parts 523 is electrically connected to the one bus bar 501, while the other lead part 525 is electrically connected to the other bus bar 503. When a large voltage is inputted to a circuit by static electricity in a direction where a normal electromotive force flows to the diode, the diode 521 protects the LED from breakdown by the large voltage. In a direction where a counter electromotive force flows to the diode, the diode 521 blocks electrical connection, and thus, protects the LED from the breakdown in the same manner.

### SUMMARY OF THE INVENTION

However, in the conventional connection structure of the electronic components, two kinds of the bus bars 501, 503 which are provided with connection parts (the pressure-contacting blades 515, 515, 517, 519) having different sizes according to shapes and sizes of the electronic components are required. Moreover, it is possible to mount only the electronic components (the Zener diode 521, the resistor 527) having the lead parts for through holes, and there has been such a problem that it is impossible to connect the electronic components for surface mount which are recently in great demand, and hence, cost reduction is attained.

The present invention has been made in view of the above circumstances, and an object of the present invention is to provide a connection structure for an electronic component which can connect plural kinds of electronic components which are different in a pitch between contact portions, outer configuration, and size with the provision of one kind of bus bar.

The above-described object of the present invention is achieved by below-described structures.

(1) A connection structure for an electronic component, having a pair of bus bars each having a terminal portion formed on one end thereof, the pair of bus bars being spaced from each other and arranged in parallel within a housing, and the each terminal portion being formed with a pair of right and left contact spring pieces each having a bulge protruded laterally outward to be opposite sides with each other at a side of leading portions which can be abutted against each other,

wherein the respective bulges of the two adjacent inside pieces among the right and left contact spring pieces of the bus bars come in elastic contact with a pair of contact portions disposed on both lateral surfaces of an electronic component arranged between the pair of bus bars, and the respective bulges of the two outside pieces among the right and left contact spring pieces of the bus bars arranged in parallel come in elastic contact with inner walls of the housing.

According to the connection structure for the electronic component having the configuration of the above (1), the pair of bus bars having the pair of right and left contact spring pieces formed at each of the terminal portions is arranged in parallel and housed in the housing. The respective bulges of the two adjacent inside pieces among the right and left contact spring pieces of the bus bars housed in the housing come in elastic contact with the pair of contact portions disposed on both lateral surfaces of the electronic component arranged between the pair of bus bars, and the respective bulges of the two outside pieces come in elastic contact with the inner walls of the housing. In this situation, the leading portions of the pair of right and left contact spring pieces of each terminal portion are abutted against each other. As a result, the electronic component is positioned in the center between the housing inner walls at both sides thereof by allowing the both lateral surfaces to be elastically sandwiched between the inner walls of the housing through the two inside right and left contact spring pieces, and the two outside right and left contact spring pieces. Also, the two inside right and left contact spring pieces, and the two outside right and left contact spring pieces elastically support the both lateral surfaces of the electronic component with respect to the inner walls of the housing. Therefore, the dimensional change of the housing can be absorbed by the bend tolerance range of the respective first right and left contact spring pieces. Under the circumstances, the right and left contact spring pieces of the bus bars can prevent the backlash of the electronic component to obtain the appropriate contact load.

Accordingly, the terminal portions between the pair of bus bars, which are arranged in parallel at a desired interval can be connected with a variety of electronic components which are different in inter-contact pitch, outer configuration, and size.

(2) A connection structure for an electronic component having a pair of bus bars each having a terminal portion formed on one end thereof, the pair of bus bars being spaced from each other and arranged in parallel within a housing, and each terminal portion being formed with at least first and second right and left contact spring pieces, which is configured to come in elastic contact with each pair of contact portions of at least first and second electronic components, arranged at a multistage,

wherein each terminal portion at a first stage of the bus bars is formed with a pair of facing first right and left contact spring pieces each having a bulge protruded horizontally outward at a side of leading portions that is configured to be abutted against each other, the respective bulges of two adjacent inside pieces among the first right and left contact spring pieces of the bus bars come in elastic contact with a pair of contact portions disposed on both lateral surfaces of the first electronic component which is arranged between the pair of bus bars, and the respective bulges of two adjacent outside pieces among the first right and left contact spring pieces of the bus bars arranged in parallel come in elastic contact with inner walls of the housing, and each terminal portion at a second stage of the bus bars is formed with a pair of parallel second right and left contact spring pieces, and

wherein at least any two pieces of the second right and left contact spring pieces of the bus bars are connected with a pair of the contact portions disposed on one surface of the second electronic component which is disposed between the bus bars.

According to the connection structure for the electronic component having the configuration of the above (2), the pair of bus bars each having the terminal portion in which at least the first and second right and left contact spring pieces are arranged at a multistage, are arranged in parallel, and housed in the housing. The respective bulges of the two adjacent inside pieces among the four first right and left contact spring pieces at the first stage of the bus bars housed in the housing come in elastic contact with the pair of contact portions disposed on both lateral surfaces of the first electronic component which is arranged between the pair of bus bars, and the respective bulges of the two outside pieces among the first right and left contact spring pieces of the bus bars arranged in parallel come in elastic contact with the inner walls of the housing. In this situation, since the leading portions of the first right and left contact spring pieces of each terminal portion are abutted against each other, the first electronic component is positioned in the center between the housing inner walls at both sides thereof by allowing the both lateral surfaces to be elastically sandwiched between the inner walls of the housing through the two inside first right and left contact spring pieces, and the two outside first right and left contact spring pieces. Also, the two inside first right and left contact spring pieces, and the two outside first right and left contact spring pieces elastically support the both lateral surfaces of the first electronic component with respect to the inner walls of the housing. As a result, the dimensional change of the housing can be absorbed by the bend tolerance range of the respective first right and left contact spring pieces. Under the circumstances, the first right and left contact spring pieces of the bus bars can prevent the backlash of the first electronic component to obtain the appropriate contact load. Also, at least any two pieces of the second right and left contact spring pieces at the second stage are connected with the pair of the contact portions disposed on one surface of the second electronic component which is disposed between the bus bars.

Under the circumstances, each stage of the terminal portions between the pair of bus bars arranged in parallel can be connected with plural kinds of first and second electronic components different in the inter-contact pitch, the outer configuration, and the size.

Also, the first electronic component having the pair of contact portions disposed on the both lateral surfaces is brought into elastic contact with the first right and left contact spring pieces at the first stage from a direction of sandwiching the both lateral surfaces. This makes it possible to prevent the backlash of the bus bars with respect to the terminal portion, and enables stable electric continuity between the first right and left contact spring pieces of the bus bars and the contact portions of the light emitting element contact portions 23 of the first electronic component.

Further, at least the pair of bus bars arranged in parallel can have the same configuration, and one kind of bus bar configuration can be provided.

(3) In the connection structure for an electronic component according to the above (2), each of the bus bars is bent into a U-shape so that a pair of lateral walls becomes parallel to each other, and the first and second right and left contact spring pieces are punched in each of the lateral walls.

According to the connection structure for the electronic component having the configuration of the above (3), the main body of each bus bar is bent into the U-shape, and the first and second right and left contact spring pieces are formed in a pair of facing lateral walls thereof by punching. As a result, the elastic contact structure having a large number of electronic contact portions can be manufactured easily and easily.

According to the connection structure for the electronic component in the present invention, the electronic components different in the pitch between the contact portions, the outer configuration, and the size can be connected with the provision of one kind of bus bar, and even when the contact portions on the lateral surface sides of the electronic component are connected, an influence of the dimension tolerance and the contraction of the housing can be ignored, and the stable connection can be conducted.

### BRIEF DESCRIPTION OF THE DRAWINGS

In the accompanying drawings:

FIG. 1 is a perspective view of a pair of bus bars used in a connection structure for an electronic component according to an embodiment of the present invention;

FIG. 2 is a perspective view of a housing that houses the bus bars illustrated in FIG. 1;

FIG. 3A is a side view of the housing that houses the bus bars, and FIG. 3B is a cross-sectional view taken along a line A-A of FIG. 3A;

FIG. 4A is a side view of the bus bar illustrated in FIG. 1, FIG. 4B is a plan view thereof, and FIG. 4C is a front view thereof;

FIG. 5 is a cross-sectional view of each electronic component mount portion of the pair of bus bars in a state where first and second electronic components are mounted;

FIG. 6A is a perspective view of a semiconductor light emitting element, and FIG. 6B is a perspective view of a zener diode;

FIG. 7 is a diagram illustrating a process of assembling the electronic component in a connection structure for the electronic component according to the embodiment of the present invention;

FIG. 8 is a diagram illustrating the process of assembling the electronic component in which a housing is notched in the connection structure for the electronic component;

FIG. 9 is a diagram illustrating the process of assembling resistors in the connection structure for the electronic component;

FIG. 10 is a plan view of the connection structure for the electronic component after a joining portion is broken;

FIG. 11 is a diagram illustrating a process of assembling the housing in the connection structure for the electronic component;

FIG. 12 is a diagram illustrating a process of assembling an electric wire holder in the connection structure for the electronic component;

FIG. 13 is a perspective view of an LED unit using the connection structure for the electronic component according to the embodiment of the present invention; and

FIG. 14 is a perspective view of a main portion of a related art connection structure for an electronic component.

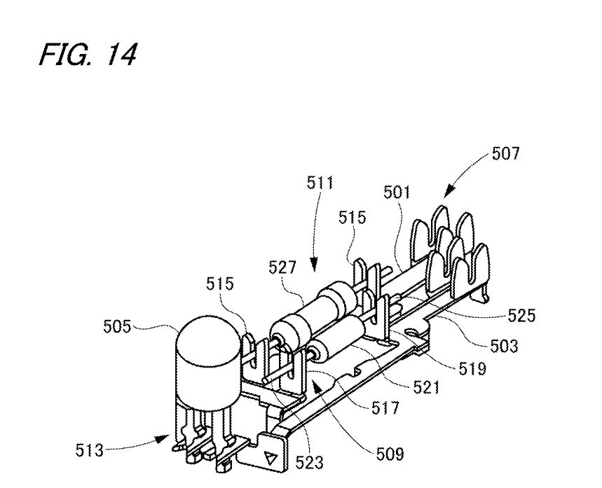

### DETAILED DESCRIPTION OF THE EXEMPLARY EMBODIMENTS

Hereinafter, an embodiment according to the present invention will be described with reference to the accompanying drawings.

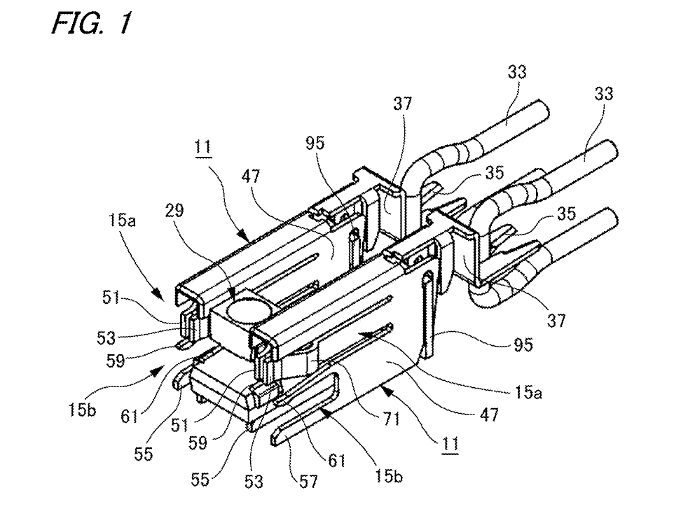

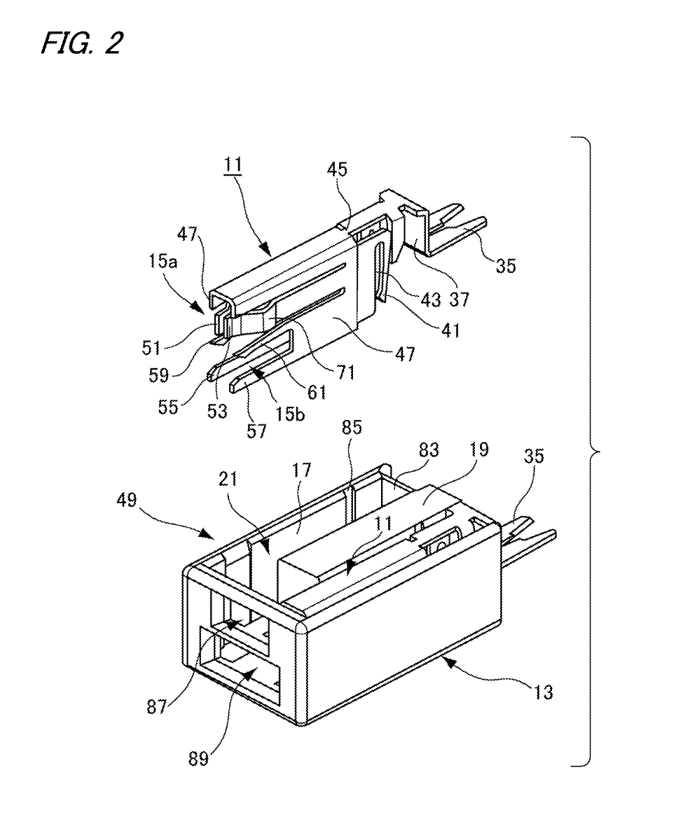

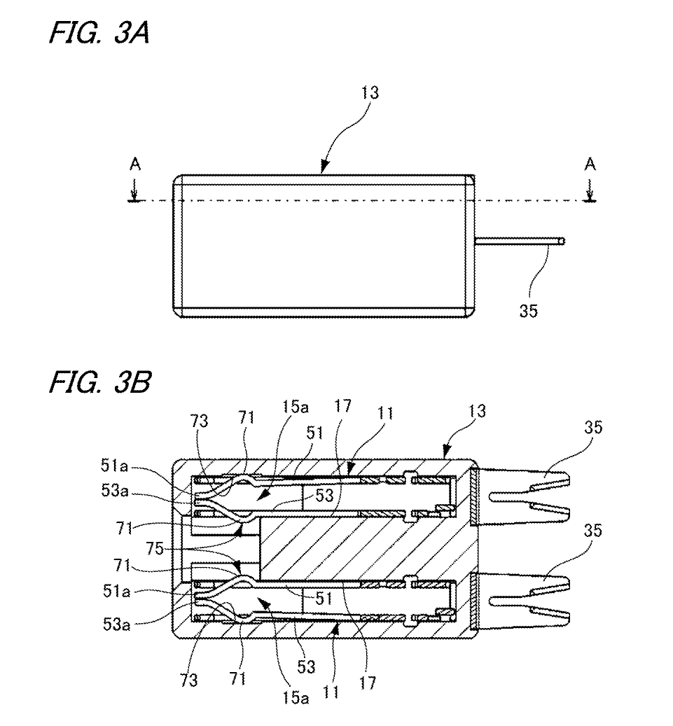

FIG. 1 is a perspective view of two bus bars used in a connection structure for an electronic component according to an embodiment of the present invention. FIG. 2 is a perspective view of a housing that houses the bus bars illustrated in FIG. 1. FIG. 3A is a side view of the housing that houses the bus bars, and FIG. 3B is a cross-sectional view taken along a line A-A of FIG. 3A.

The connection structure for the electronic component according to this embodiment has two bus bars 11 having the same configuration illustrated in FIG. 1 as a main portion of the configuration. The two bus bars 11 are housed in a housing 13 illustrated in FIG. 2 in use.

Each of the two bus bars 11 according to this embodiment is formed with two upper and lower terminal portions 15a and 15b on one end thereof. As illustrated in FIG. 2, the bus bars 11 are housed into a pair of bus bar chambers 17 of the housing 13 formed into a cuboid from a bus bar insertion opening 21 of a housing upper surface 19 so as to be spaced from each other in parallel. The bus bar chambers 17 partially communicate with each other inside of the housing 13.

The bus bars 11 according to this embodiment each include the two upper and lower terminal portions 15a and 15b so as to connect a semiconductor 29 and a zener diode 31 which are plural kinds (two kinds in this embodiment) of first and second electronic components. However, the connection structure for the electronic component according to the present invention is not limited to this configuration, but may be applied to a configuration having only one terminal portion 15a, or a configuration having three or more terminal portions.

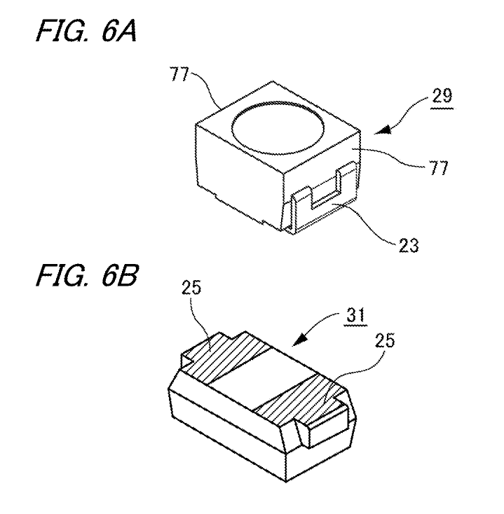

The upper (first) terminal portion 15a is formed with a pair of facing first right and left contact spring pieces 51 and 53 that can come in elastic contact with each of light emitting element contact portions 23 (refer to FIGS. 6A and 6B) which are a pair of contact portions of a semiconductor light emitting element 29. The lower (second) terminal portion 15b is formed with a pair of parallel second right and left contact spring pieces 59 and 61 that can come in elastic contact with each of diode contact portions (refer to FIGS. 6A and 6B) which are a pair of contact portions of a zener diode 31, and right and left component seats 55 and 57 that sandwiches the zener diode 31 in cooperation with those respective second right and left contact spring pieces 59 and 61, so that the second right and left contact spring pieces 59 and 61 face the right and left component seats 55 and 57.

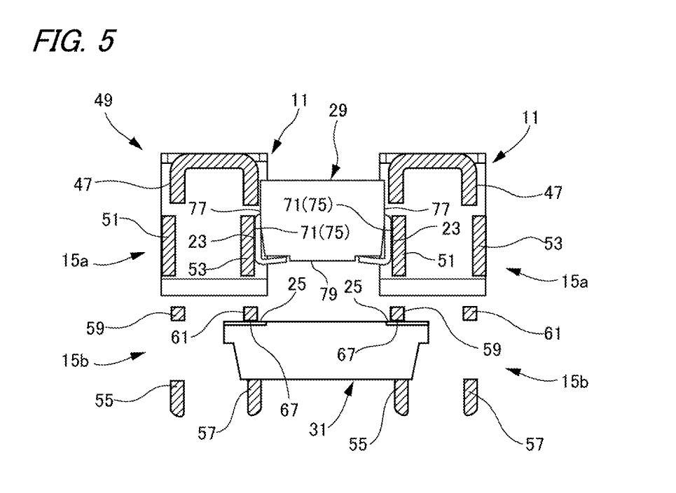

In this embodiment, as illustrated in FIG. 1, two adjacent inside first right and left contact spring pieces 51 and 53 among the four first right and left contact spring pieces 51 and 53 at the upper stage of the two bus bars 11 arranged in parallel are connected with the pair of light emitting element contact portions 23 disposed on both lateral surfaces 77 of the semiconductor light emitting element 29 arranged between the two bus bars 11 (refer to FIG. 5). Also, electric contact portions of the two adjacent inside second right and left contact spring pieces 61 and 59 among the four second right and left contact spring pieces 59, 61, 59, and 61 at the lower stage of the two bus bars 11 arranged in parallel are connected with a pair of diode contact portions 25 disposed on one surface of the zener diode 31 which is located below the semiconductor light emitting element 29 between the two bus bars 11 (refer to FIG. 5).

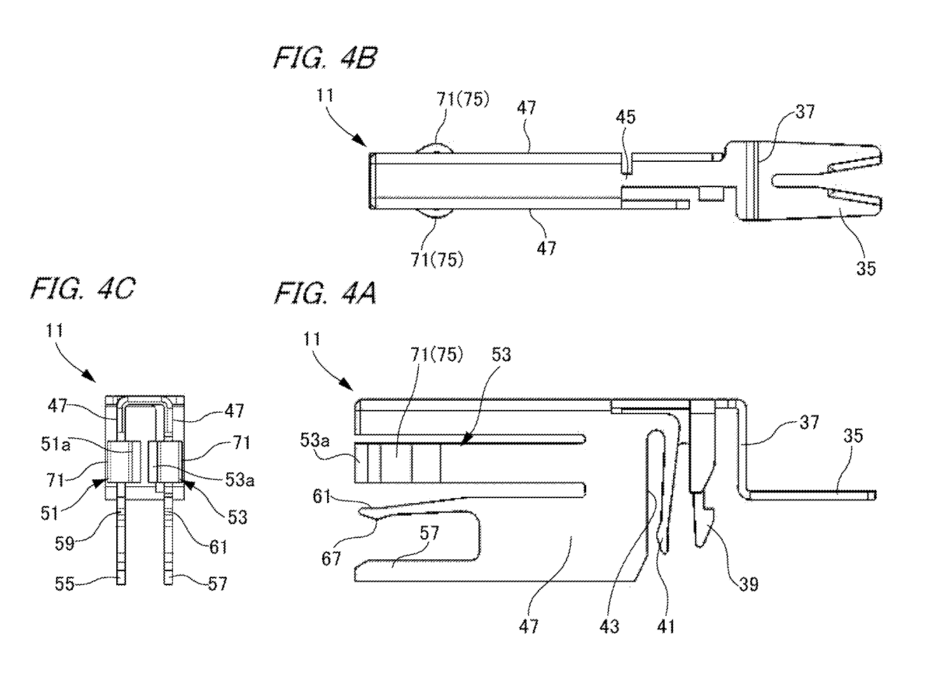

As illustrated in FIGS. 3A and 3B, the bus bars 11 are partially protruded to the external of the housing 13 in a state where the bus bars 11 are mounted in the housing 13. In this embodiment, a side at which parts of the bus bars 11 are protruded from the housing 13 is called “rear”, and an opposite side thereof is called “front”. Each rear end of the bus bars 11 is equipped with a crimping blade 35 for cutting a coating of a coated electric wire 33 to allow the electric wire 33 to electrically contact with a conductor. As illustrated in FIG. 4A, a rear abutment piece 37, a rear elastic leg 39, a front elastic leg 41, and a front abutment edge 43 are consecutively connected in the stated order on a front portion of the crimping blade 35.

As illustrated in FIG. 4B, a joining portion 45 is formed between the front abutment edge 43 and the terminal portion 15a in each of the bus bars 11. The joining portion 45 can be broken after the bus bar 11 has been housed into the housing 13. The crimping blade 35, the rear abutment piece 37, the rear elastic leg 39, the front elastic leg 41, the front abutment edge 43, and the upper and lower terminal portions 15a, 15b are punched out integrally by a sheet-metal working, and thereafter bent into a shape illustrated in FIG. 2. The terminal portions 15a and 15b of each bus bar 11 are bent into a U-shape so that a pair of lateral walls 47 is arranged in parallel, and the first and second right and left contact spring pieces 51, 53, 59, and 61, and the right and left component seats 55 and 57 are punched in each of the lateral walls 47. A main body of the bus bar 11 is bent into a U-shape, and the first and second right and left contact spring pieces 51, 53, 59, and 61, and the right and left component seats 55 and 57 are formed in the pair of facing lateral walls 47 by punching, thereby making it possible to easily and compactly manufacture an elastic contact structure having a large number of electric contact portions.

FIG. 5 is a cross-sectional view of each electronic component mount portion 49 (refer to FIG. 2) of the pair of bus bars 11 in a state where the first and second electronic components are mounted. FIG. 6A is a perspective view of the semiconductor light emitting element 29, and FIG. 6B is a perspective view of the zener diode 31.

The pair of bus bars 11 having the same configuration are arranged in parallel and housed in the housing 13, whereby the first and second right and left contact spring pieces 51, 53, 59, and 61 are arranged in four at each of the upper and lower stages, eight at two upper and lower stages in total, inside of the housing 13, as illustrated in FIG. 5.

As illustrated in FIG. 3, the first right and left contact spring pieces 51 and 53 arranged in the upper terminal portion 15a are formed with bulges 71 protruded horizontally outward on a side of leading portions 51a and 53a that can be abutted against each other, which are formed as flexible pieces that can be elastically deformed in the horizontal direction of the bus bars 11 with the leading portions 51a and 53a that are abutted against each other as free ends.

The bulges 71 of the two adjacent inside first right and left contact spring pieces 51 and 53 among the first right and left contact spring pieces 51 and 53 of the pair of bus bars 11 arranged in parallel within the housing 13 come in elastic contact with the light emitting element contact portions 23 of the both lateral surfaces 77 of the semiconductor light emitting element 29 arranged between the pair of bus bars 11. Also, the bulges 71 of the two outside first right and left contact spring pieces 51 and 53 among the first right and left contact spring pieces 51 and 53 of the pair of bus bars 11 come in elastic contact with respective inner lateral walls (inner walls) 73 of the housing 13. That is, the bulges 71 of the two inside first right and left contact spring pieces 51 and 53 form electric contact portions 75.

On the other hand, the second right and left contact spring pieces 59 and 61 arranged in the lower terminal portions 15b are each formed with an electric contact portion 67 having a triangular shape whose vertex is protruded downward in a leading portion thereof, which is formed as a flexible piece that can be elastically deformed in a vertical direction of the bus bars 11 with the leading portion as a free end. The electric contact portions 67 of those two second right and left contact spring pieces 59 and 61 face the right and left component seats 55 and 57.

The electric contact portions 67 of the two adjacent inside second right and left contact spring pieces 61 and 59 among the second right and left contact spring pieces 59 and 61 of the pair of bus bars 11 arranged in parallel within the housing 13 come in elastic contact with the pair of diode contact portions 25 on one surface of the zener diode 31 which is arranged between the pair of bus bars 11, and the right and left component seats 55 and 57 are abutted against the other surface of the zener diode 31.

As illustrated in FIG. 6A, the semiconductor light emitting element 29 is an electronic component having the pair of light emitting element contact portions 23 disposed on the both lateral surfaces 77, and the light emitting element contact portions 23 are each formed into an L-shape continuous from each of the both lateral surfaces 77 of the semiconductor light emitting element 29 to an element lower surface 79, and fixed thereto (refer to FIG. 5). The light emitting element contact portions 23 fixed to the both lateral surfaces 77 are each inclined in an L-shape with respect to the both lateral surfaces 77. As illustrated in FIG. 6B, the zener diode 31 is an electronic component for surface mount having the pair of diode contact portions 25 on one surface thereof.

As illustrated in FIG. 5, the both lateral surfaces 77 of the semiconductor light emitting element 29 face the electric contact portions 75 of the two adjacent inside first right and left contact spring pieces 51 and 53 among the first right and left contact spring pieces 51 and 53 of the pair of bus bars 11 arranged in parallel. One surface of the zener diode 31 on which the diode contact portions 25 are provided faces a side of the electric contact portions 67 of the second right and left contact spring pieces 61 and 59, and the other surface (rear surface) thereof is abutted against the lower right and left component seats 55 and 57.

In this embodiment, an inter-contact pitch of the semiconductor light emitting element 29 is different from an inter-contact pitch of the zener diode 31, and contact location directions of the light emitting element contact portions 23 and the diode contact portions 25 are also different from each other. That is, those two electronic components are different in the inter-contact pitch and the contact structure. In the connection structure for the electronic component according to this embodiment, two kinds of electronic components having the different contact structure can be mounted at the same time.

That is, as illustrated in FIG. 5, the bulges 71 (electric contact portions 75) of the two adjacent inside first right and left contact spring pieces 51 and 53 among the four first right and left contact spring pieces 51 and 53 at the upper stage of the bus bars 11 arranged in parallel come in elastic contact with the pair of light emitting element contact portions 23 disposed on both lateral surfaces of the semiconductor light emitting element 29. The bulges 71 of the two outside first right and left contact spring pieces 51 and 53 among the first right and left contact spring pieces 51 and 53 of the pair of bus bars 11 come in elastic contact with the respective inner lateral walls 73 of the housing 13. Also, the electric contact portions 67 of the two adjacent inside second right and left contact spring pieces 61 and 59 among the four second right and left contact spring pieces 59 and 61 at the lower stage of the bus bars 11 arranged in parallel come in elastic contact with the pair of diode contact portions 25 disposed on one surface of the zener diode 31, and are abutted against the two adjacent inside right and left component seats 55 and 57 among the four second right and left component seats 55, 57, 55, and 57 disposed below.

In the connection structure for the electronic component according to this embodiment, as illustrated in FIG. 5, the zener diode 31 is connected with the second right and left contact spring piece 61 which is located second from the left side, and the second right and left contact spring piece 59 which is located third from the left side among the four second right and left contact spring pieces 59 and 61 at the lower stage of the bus bars 11 arranged in parallel. On the contrary, the zener diode 31 can be connected with the second right and left contact spring piece 59 which is located first from the left side, and the second right and left contact spring piece 59 which is located third from the left side. Also, the zener diode 31 can be connected with the second right and left contact spring piece 61 which is located second from the left side, and the second right and left contact spring piece 61 which is located fourth from the left side. Further, the zener diode 31 can be connected with the second right and left contact spring piece 59 which is located first from the left side, and the second right and left contact spring piece 61 which is located fourth from the left side. Thus, the zener diode 31 can be connected with the spring pieces having the different inter-contact pitches or the different contact points.

Subsequently, a process of assembling the connection structure for the electronic component having the above configuration will be described.

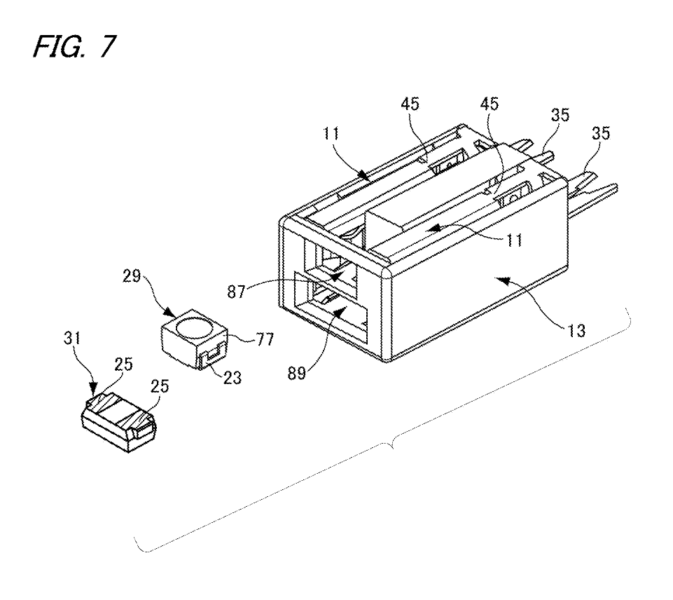

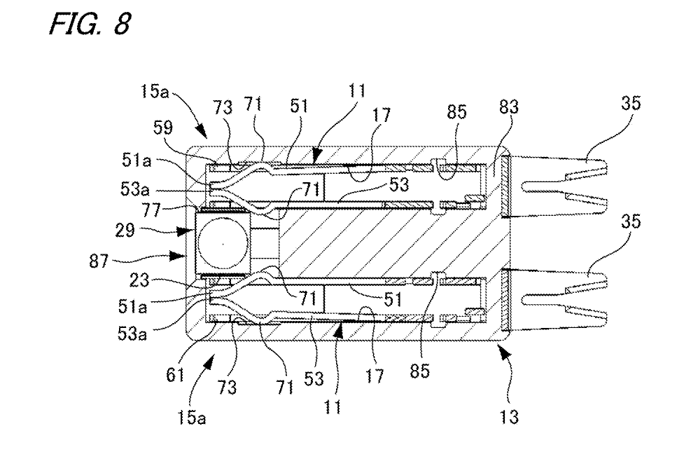

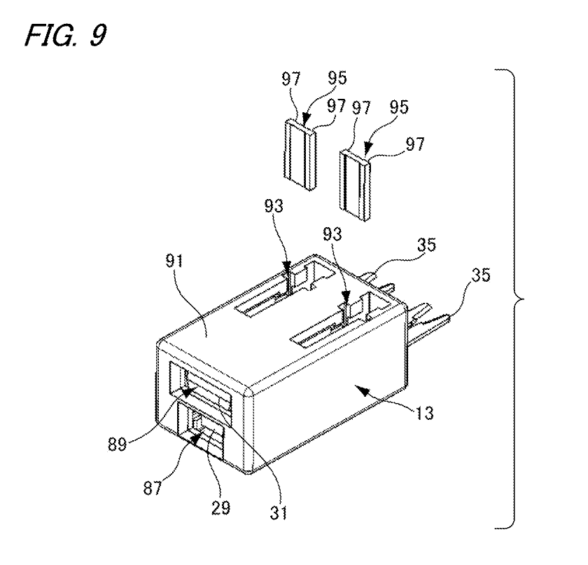

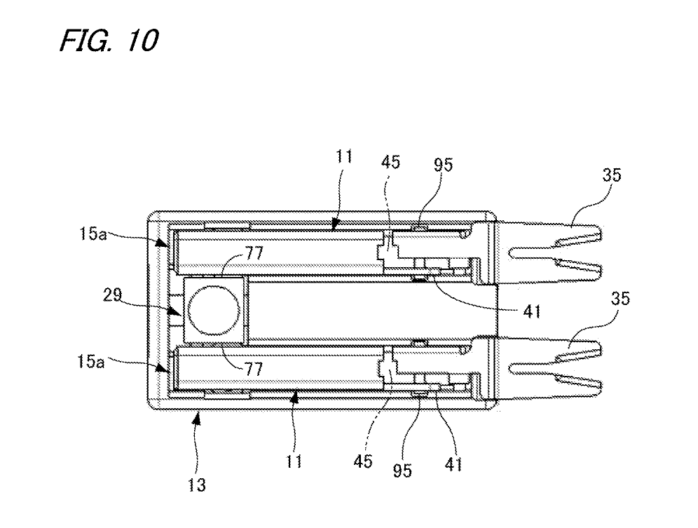

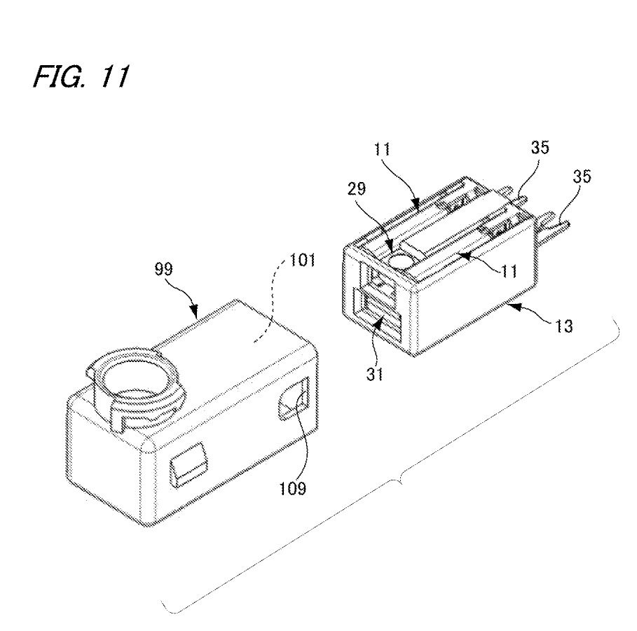

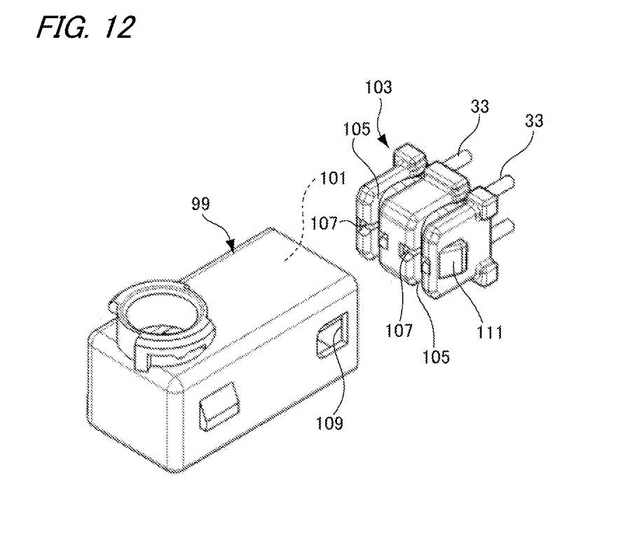

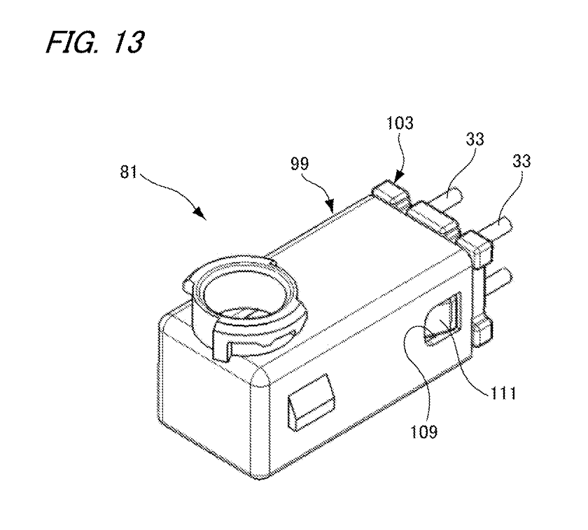

FIG. 7 is a diagram illustrating a process of assembling the electronic component in the connection structure for the electronic component according to the embodiment of the present invention. FIG. 8 is a diagram illustrating the process of assembling the electronic component in which the housing 13 is notched likewise. FIG. 9 is a diagram illustrating the process of assembling resistors likewise. FIG. 10 is a plan view of the connection structure for the electronic component after the joining portion 45 is broken likewise. FIG. 11 is a diagram illustrating a process of assembling the housing likewise. FIG. 12 is a diagram illustrating a process of assembling an electric wire holder likewise. FIG. 13 is a perspective view of an LED unit 81 using the connection structure for the electronic component according to the embodiment of the present invention.

The connection structure for the electronic component can be preferably applied to, for example, the LED unit 81 illustrated in FIG. 13. In order to apply the connection structure for the electronic component to the LED unit 81, the pair of bus bars 11 is mounted in the housing 13 as illustrated in FIG. 7.

The two bus bar chambers 17 are formed in the housing 13. The bus bar chambers 17 have a rear wall 83 (refer to FIG. 2) at rear ends thereof, and a pair of holding grooves 85 is formed in an inner wall surface in front of the rear wall 83 of each bus bar chamber 17. The bus bars 11 inserted into each of the bus bar chambers 17 sandwich the rear wall 83 between the rear abutment piece 37 and the rear elastic leg 39 so as to regulate a dropout from the housing 13.

An LED mount opening portion 87 and a diode mount opening portion 89 are formed at two upper and lower stages in a front surface of the housing 13. The semiconductor light emitting element 29 is inserted into the LED mount opening portion 87 with the light emitting element contact portions 23 fixed to the both lateral surfaces 77. The zener diode 31 is inserted into the diode mount opening portion 89 with the diode contact portions 25 disposed on an upper side. As a result, as illustrated in FIG. 5, the light emitting element contact portions 23 and the diode contact portions 25 are connected to the electric contact portions 75 of the first right and left contact spring pieces 51 and 53, and the electric contact portions 67 of the second right and left contact spring pieces 61 and 59, respectively.

In this example, as illustrated in FIG. 8, the semiconductor light emitting element 29 is inserted into the LED mount opening portion 87 while pushing out the bulges 71 of the first right and left contact spring piece 53 and the first right and left contact spring piece 51 which face the both lateral surfaces 77. In this situation, the leading portions 51a and 53a of the first right and left contact spring pieces 51 and 53 of the respective terminal portions 15a are abutted against each other, the two inside first right and left contact spring pieces 53 and 51 which have been pushed out push the two outside first right and left contact spring pieces 51 and 53 toward the inner lateral walls 73 of the housing 13. Accordingly, the two inside first right and left contact spring pieces 53 and 51 are subject to a reaction force in a direction of bringing the first right and left contact spring pieces 53 and 51 close to each other from the inner lateral walls 73 of the housing 13. As a result, the semiconductor light emitting element 29 is positioned in the center between the inner lateral walls 73 of the housing 13 at both sides thereof by allowing the both lateral surfaces 77 to be elastically sandwiched between the inner lateral walls 73 of the housing 13 through the two inside first right and left contact spring pieces 53, 51, and the two outside first right and left contact spring pieces 51, 53.

Also, the two inside first right and left contact spring pieces 53, 51, and the two outside first right and left contact spring pieces 51, 53 elastically support the both lateral surfaces 77 of the semiconductor light emitting element 29 with respect to the inner lateral walls 73 of the housing 13. Therefore, a dimensional change of the housing 13 can be absorbed by a bend tolerance range of the respective first right and left contact spring pieces 51 and 53. Under the circumstances, the first right and left contact spring pieces 51 and 53 of the bus bars 11 can prevent the backlash of the semiconductor light emitting element 29 to obtain an appropriate contact load.

Further, the semiconductor light emitting element 29 having the pair of light emitting element contact portions 23 disposed on the both lateral surfaces 77 is brought into elastic contact with the pair of first right and left contact spring pieces 51 and 53 from a direction of sandwiching the both lateral surfaces 77 to enable stable electric continuity with the terminal portions 15a of the bus bars 11.

As illustrated in FIG. 9, resistor mount opening portions 93 are formed in a bottom surface 91 of the housing 13, and resistors 95 are inserted into the respective resistor mount opening portions 93. As a result, the resistor 95 is sandwiched between the front abutment edge 43 (refer to FIG. 4) and the front elastic leg 41 in each of the bus bars 11, and an electric contact portion of the front elastic leg 41 is connected to a pair of resistor contact portions 97 of the resistor 95.

In this example, the LED unit 81 according to this embodiment needs to be a circuit having the semiconductor light emitting element 29, the zener diode 31, and a circuit providing each of the resistors 95 between a positive electrode and a negative electrode. Under the circumstance, the joining portion 45 is formed between the front abutment edge 43 and the terminal portion 15a in each of the bus bars 11. As illustrated in FIG. 10, the joining portion 45 is cut whereby, in each of the bus bars 11, the other resistor contact portion 97 of the resistor 95 having one resistor contact portion 97 brought in contact with the crimping blade 35 comes in contact with the front elastic leg 41. This leads to a circuit in which each of the resistors 95 is disposed in series between the crimping blade 35 and the terminal portion 15a.

As illustrated in FIG. 11, the housing 13 in which the semiconductor light emitting element 29 and the zener diode 31 are mounted is mounted in a lens cover 99. A housing insertion opening 101 is formed in a rear end surface of the lens cover 99. The crimping blades 35 are protruded from the housing 13 inserted into the lens cover 99, backward within the lens cover 99.

As illustrated in FIG. 12, an electric wire holder 103 is inserted into the lens cover 99 in which the housing 13 is mounted, from the housing insertion opening 101. U-shaped electric wire holding grooves 105 are formed in three-side outer surfaces of the electric wire holder 103 at two portions. Coated electric wires 33 are each bent in a U-shape and fitted into the respective electric wire holding grooves 105. Horizontal crimping blade entrance slits 107 are formed across the respective electric wire holding grooves 105 in a front surface of the electric wire holder 103. With this configuration, when the electric wire holder 103 is inserted into the lens cover 99, the respective crimping blades 35 of the bus bars 11, which are protruded backward within the lens cover 99, enter the horizontal crimping blade entrance slits 107 so that the crimping blades 35 and the conductors of the electric wires 33 are connected to each other.

Locking claws 111 protruded from the lateral surfaces of the electric wire holder 103 inserted into the lens cover 99 is locked with locking holes 109 formed in lateral portions of the lens cover 99 to regulate disengagement of the housing 13 and the electric wire holder 103 per se from the lens cover 99. The housing 13 and the electric wire holder 103 are mounted in the lens cover 99 to configure the LED unit 81 illustrated in FIG. 13.

Thus, in the connection structure for the electronic component according to this embodiment, the pair of bus bars 11 having the terminal portions 15a and 15b in which the first and second right and left contact spring pieces 51, 53, 59, and 61 are arranged at the upper and lower stages are spaced from each other, and arranged in parallel within the housing 13. The respective bulges 71 of the two adjacent inside first right and left contact spring pieces 51 and 53 among the four first right and left contact spring pieces 51, 53, 51, and 53 at the upper stage of the bus bars 11 housed within the housing 13, and arranged in parallel come in elastic contact with the pair of light emitting element contact portions 23 disposed on the both lateral surfaces 77 of the semiconductor light emitting element 29 which is arranged between the pair of bus bars 11. Also, the bulges 71 of the two outside first right and left contact spring pieces 51 and 53 among the four first right and left contact spring pieces 51, 53, 51, and 53 at the upper stage of the bus bars 11 arranged in parallel come in elastic contact with the respective inner lateral walls 73 of the housing 13.

In this situation, the leading portions 51a and 53a of the first right and left contact spring pieces 51 and 53 of the terminal portion 15a in each of the bus bars 11 are abutted against each other. As a result, the semiconductor light emitting element 29 is positioned in the center between the inner lateral walls 73 of the housing 13 at both sides thereof by allowing the both lateral surfaces 77 to be elastically sandwiched between the inner lateral walls 73 of the housing 13 through the two inside first right and left contact spring pieces 53, 51, and the two outside first right and left contact spring pieces 51, 53.

Also, the two inside first right and left contact spring pieces 53, 51, and the two outside first right and left contact spring pieces 51, 53 elastically support the both lateral surfaces 77 of the semiconductor light emitting element 29 with respect to the inner lateral walls 73 of the housing 13. Therefore, the dimensional change of the housing 13 can be absorbed by the bend tolerance range of the respective first right and left contact spring pieces 51 and 53. Under the circumstances, the first right and left contact spring pieces 51 and 53 of the bus bars 11 can prevent the backlash of the semiconductor light emitting element 29 to obtain the appropriate contact load. Also, at least any two of the four second right and left contact spring pieces 59, 61, 59, and 61 at the lower stage of the bus bars 11 arranged in parallel are connected with the pair of diode contact portions 25 disposed on one surface of the zener diode 31 which is arranged between the bus bars 11.

Under the circumstances, the upper and lower terminal portions 15a and 15b between the pair of bus bars 11 arranged in parallel can be connected with the semiconductor light emitting element 29 and the zener diode 31 which are different in inter-contact pitch, outer configuration, and size from each other.

Also, the semiconductor light emitting element 29 having the pair of light emitting element contact portions 23 disposed on the both lateral surfaces 77 is brought into elastic contact with the pair of first right and left contact spring pieces 51 and 53 from a direction of sandwiching the both lateral surfaces 77. This makes it possible to prevent the backlash of the bus bars 11 with respect to the terminal portion 15a, and enables stable electric continuity between the first right and left contact spring pieces 51 and 53 of the bus bars 11 and the light emitting element contact portions 23 of the semiconductor light emitting element 29.

Also, the two bus bars 11 having two pairs of parallel first right and left contact spring pieces 51 and 53, and the second right and left contact spring pieces 59 and 61 formed therein are spaced from each other in parallel. As a result, the upper terminal portion 15a can be connected with the semiconductor light emitting element 29 different in size and contact location direction from the zener diode 31.

Also, the four second right and left contact spring pieces 59, 61, 59, and 61 at the lower terminal portions 15b can be also connected with four kinds of zener diodes 31 different in the inter-contact pitch and the contact position.

Further, plural kinds of housings 13 different in the interval between the pair of bus bar chambers 17 are prepared, and the pair of bus bars 11 is arranged in parallel at the different interval within the housing 13, to thereby enable plural kinds of semiconductor light emitting elements different in the inter-contact pitch and the size to be connected with the housings 13.

As described above, according to the connection structure for the electronic component of this embodiment, the kind of bus bars 11 is limited to one, and the semiconductor light emitting element 29 and the zener diode 31, which are different in the pitch between the contact portions, the outer configuration, and the size can be connected to the connection structure. Even if the connection structure are connected to the light emitting element contact portions 23 on the lateral surface sides of the semiconductor light emitting element 29, an influence of the dimension tolerance and the contraction of the housing 13 can be ignored, and the stable connection can be conducted.

The connection structure for the electronic component according to the present invention is not limited to the above-mentioned embodiment, but can be appropriately deformed and improved. In addition, the material, configuration, dimension, the number, and installation location of the respective constituent elements in the above-mentioned embodiment are arbitrarily, and not limited if the present invention can be achieved.

The present invention is useful for providing a connection structure for an electronic component which can connect plural kinds of electronic components which are different in a pitch between contact portions, outer configuration, and size with the provision of one kind of bus bar.

What is claimed is:

1. A connection structure for an electronic component, having a pair of bus bars each having a terminal portion formed on one end thereof, the pair of bus bars being spaced from each other and arranged in parallel within a housing, and the each terminal portion being formed with a pair of right and left contact spring pieces each having a bulge protruded laterally outward to be opposite sides with each other at leading end side of the terminal portion, the terminal portion being adapted to be abutted against each other at the leading end,
wherein the respective bulges of the two adjacent inside pieces among the right and left contact spring pieces of the bus bars come in elastic contact with a pair of contact portions disposed on both lateral surfaces of an electronic component arranged between the pair of bus bars, and the respective bulges of the two outside pieces among the right and left contact spring pieces of the bus bars arranged in parallel come in elastic contact with inner walls of the housing.

2. A connection structure for electronic components having a pair of bus bars each having a terminal portion formed on one end thereof, the pair of bus bars being spaced from each other and arranged in parallel within a housing, and each terminal portion being formed with at least first and second right and left contact spring pieces, which is configured to come in elastic contact with each pair of contact portions of at least first and second electronic components, arranged at a multistage,
wherein each terminal portion at a first stage of the bus bars is formed with a pair of first right and left contact spring pieces each having a bulge protruded laterally outward at leading end side of the terminal portion, the terminal portion being adapted to be abutted against each other at the leading end, the respective bulges of two adjacent inside pieces among the first right and left contact spring pieces of the bus bars come in elastic contact with a pair of contact portions disposed on both lateral surfaces of the first electronic component which is arranged between the pair of bus bars, and the respective bulges of two adjacent outside pieces among the first right and left contact spring pieces of the bus bars arranged in parallel come in elastic contact with inner walls of the housing, and each terminal portion at a second stage of the bus bars is formed with a pair of parallel second right and left contact spring pieces, and
wherein at least any two pieces of the second right and left contact spring pieces of the bus bars are connected with a pair of the contact portions disposed on one surface of the second electronic component which is disposed between the bus bars.

3. The connection structure for an electronic component according to claim 2, wherein each of the bus bars is bent into a U-shape so that a pair of lateral walls becomes parallel to each other, and the first and second right and left contact spring pieces are punched in each of the lateral walls.
